(19) United States
(12) Patent Application Publication
(10) Pub. No.: US 2014/0359519 A1
(43) Pub. Date: Dec. 4, 2014

(54) Determination of Intended Navigation Destination Based on User-Generated and Analysis-Based Information

(71) Applicant: Microsoft Corporation, Redmond, WA (US)

(72) Inventors: Kevin Y. Luu, Bellevue, WA (US); Sean Lyndersay, Mountain View, CA (US); Alexandra M. Feldman, Seattle, WA (US); Martin J. Hall, Seattle, WA (US); Zachary J. Shallcross, Bothell, WA (US); Anthony G. Amatino, London (GB); Daniel Bernhardt, London (GB); Ambarish Chitnis, Redmond, WA (US); Robert E. Kolba, JR., Seattle, WA (US); John B. Bravenec, Seattle, WA (US); Jatinder Singh Mann, Kirkland, WA (US); Swathi Ganapathi, Seattle, WA (US)

(73) Assignee: Microsoft Corporation, Redmond, WA (US)

(21) Appl. No.: 13/907,766

(22) Filed: May 31, 2013

(51) Int. Cl. G06F 17/30; G06F 3/0484

(52) U.S. Cl. CPC G06F 17/3097; G06F 3/0484
USPC 715/780; 707/767

(57) ABSTRACT

Various embodiments provide a web platform, e.g., a web browser, which is designed to facilitate user access to websites in a quick and efficient manner. The web platform includes an address bar and, as keystrokes are entered into the address bar, a user interface container is populated with relevant suggestions from a combination of various data sources based on matching character input. Data sources can include a user's browsing history, favorites, and domain suggestions from a remote source, such as a service provider.

### BACKGROUND

Today, users can consume a wide variety of web content. Typically, a user can enter search terms into a search engine to have a list of search results returned that may or may not include content of interest. This approach can fall short of providing a desirable user experience that surfaces content of interest to the user in an efficient and streamlined manner.

### SUMMARY

This Summary is provided to introduce a selection of concepts in a simplified form that are further described below in the Detailed Description. This Summary is not intended to identify key features or essential features of the claimed subject matter.

Various embodiments provide a web platform, e.g., a web browser, which is designed to facilitate user access to websites in a quick and efficient manner. The web platform includes an address bar and, as keystrokes are entered into the address bar, a user interface container is populated with relevant suggestions from a combination of various data sources based on matching character input. Data sources can include local sources and remote sources.

In one or more embodiments, the relevant suggestions can include deep link navigation suggestions, search suggestions, local application suggestions, and the like.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 illustrates an example user interface in accordance with one or more embodiments.

FIG. 4 is a flow diagram that describes steps in a method in accordance with one or more embodiments.

FIG. 5 illustrates an example user interface in accordance with one or more embodiments.

FIG. 6 is a flow diagram that describes steps in a method in accordance with one or more embodiments.

FIG. 7 illustrates an example computing device that can be utilized to implement various embodiments described herein.

### DETAILED DESCRIPTION

Overview

Various embodiments provide a web platform, e.g., a web browser, which is designed to facilitate user access to websites in a quick and efficient manner. The web platform includes an address bar and, as keystrokes are entered into the address bar, a user interface container is populated with relevant suggestions from a combination of various data sources based on matching character input. Data sources can include local sources such as typed URLs, a user's browsing history, favorites, and pinned sites. Data sources can also include remote sources such as a service provider, that can provide deep link navigation suggestions, weather suggestions, finance suggestions, local application suggestions, and search suggestions, to name just a few.

A web platform is a platform that works in connection with content of the web, e.g. public content. A web platform can include and make use of many different types of technologies such as, by way of example and not limitation, URLs, HTTP, REST, HTML, CSS, JavaScript, DOM, as well as other technologies. The web platform can also work with a variety of data formats such as XML, JSON, and the like. Web platforms can include web browsers, local applications such as Windows® Store applications that can be installed and executed on a user's local computing device, and the like.

In one or more embodiments, the relevant suggestions can include deep link navigation suggestions, search suggestions, local application suggestions, and the like. In operation, the remote source, e.g., a service provider, attempts to predict a user's intended navigation based on confidence information that is assigned to keystroke combinations that it receives from the web platform. Based on its keystroke-based prediction, the remote source can return the relevant suggestions which can then be populated, by the web platform, in a user interface container. The user can then utilize populated items in the user interface container to conduct a navigation, launch a local application, install a local application or receive answers to queries, as will become apparent below.

In the following discussion, an example environment is first described that is operable to employ the techniques described herein. Example illustrations of the various embodiments are then described, which may be employed in the example environment, as well as in other environments. Accordingly, the example environment is not limited to performing the described embodiments and the described embodiments are not limited to implementation in the example environment.

Example Operating Environment

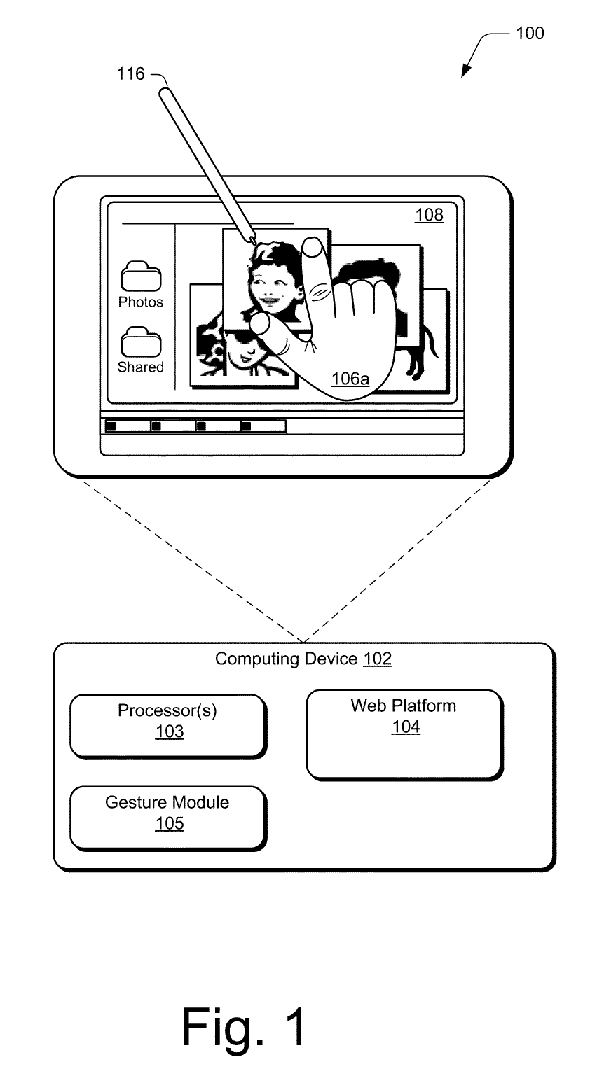

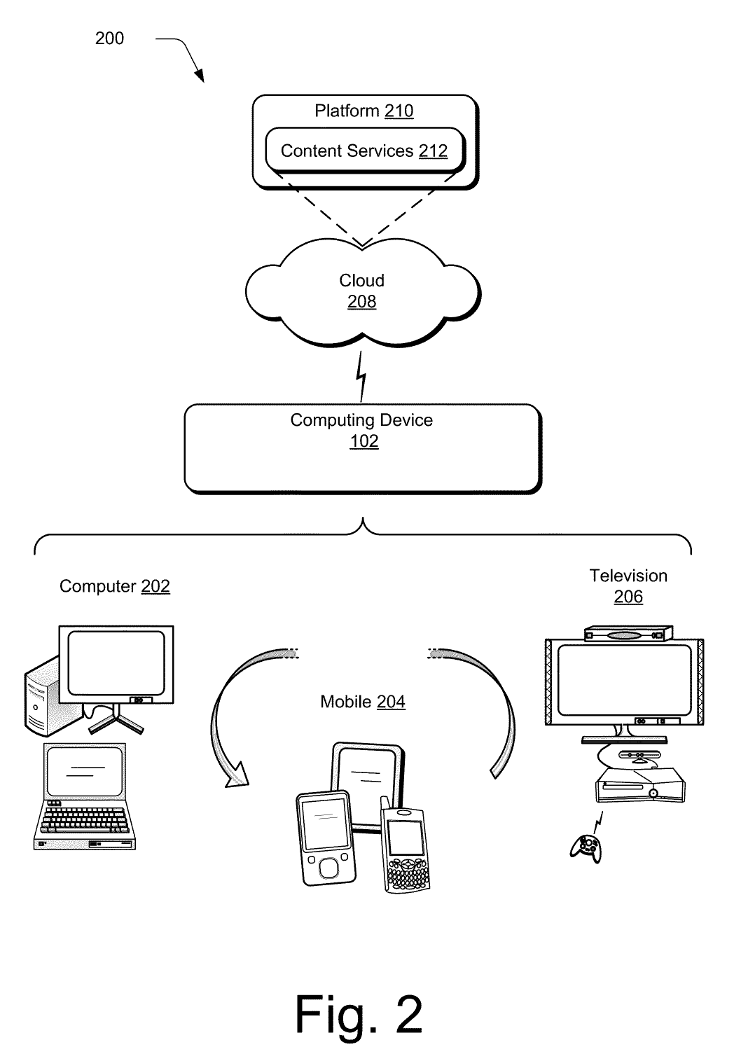

FIG. 1 is an illustration of an environment 100 in an example implementation that is operable to employ the techniques described in this document. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 also includes a web platform 104. As noted above, the web platform works in connection with content of the web, e.g. public content such as web pages and the like. A web platform can include and make use of many different types of technologies such as, by way of example and not limitation, URLs, HTTP, REST, HTML, CSS, JavaScript, DOM, and the like. The web platform can also work with a variety of data formats such as XML, JSON, and the like. Web platforms can include web browsers, local applications such as a Windows® Store application, and the like. In the examples described below, a web platform in the form of a web browser having an address bar is utilized. It is to be appreciated and understood, however, that the inventive principles can be employed by web platforms other than web browsers.

Computing device 102 also includes a gesture module 105 that recognizes input pointer gestures that can be performed by one or more fingers, and causes operations or actions to be performed that correspond to the gestures. The gestures may be recognized by module 105 in a variety of different ways. For example, the gesture module 105 may be configured to recognize a touch input, such as a finger of a user's hand 106a as proximal to display device 108 of the computing device 102 using touchscreen functionality, or functionality that senses proximity of a user's finger that may not necessarily be physically touching the display device 108, e.g., using near field technology. Module 105 can be utilized to recognize single-finger gestures and bezel gestures, multiple-finger/same-hand gestures and bezel gestures, and/or multiple-finger/different-hand gestures and bezel gestures.

The computing device 102 may also be configured to detect and differentiate between a touch input (e.g., provided by one or more fingers of the user's hand 106a) and a stylus input (e.g., provided by a stylus 116). The differentiation may be performed in a variety of ways, such as by detecting an amount of the display device 108 that is contacted by the finger of the user's hand 106a versus an amount of the display device 108 that is contacted by the stylus 116.

Thus, the gesture module 105 may support a variety of different gesture techniques through recognition and leverage of a division between stylus and touch inputs, as well as different types of touch inputs and non-touch inputs.

FIG. 2 illustrates an example system 200 that includes the computing device 102 as described with reference to FIG. 1. The example system 200 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 200, multiple devices are interconnected through a central computing device. The central computing device may be local to the multiple devices or may be located remotely from the multiple devices. In one embodiment, the central computing device may be a cloud of one or more server computers. These computers can be connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 202, mobile 204, and television 206 uses. Each of these configurations includes devices that may have generally different constructs and capabilities, and thus the computing device 102 may be configured according to one or more of the different device classes. For instance, the computing device 102 may be implemented as the computer 202 class of a device that includes a personal computer, desktop computer, a multi-screen computer, laptop computer, netbook, and so on. Each of these different configurations may employ a web platform, e.g. a web browser, as described above and below.

The computing device 102 may also be implemented as the mobile 204 class of device that includes mobile devices, such as a mobile phone, portable music player, portable gaming device, a tablet computer, a multi-screen computer, and so on. The computing device 102 may also be implemented as the television 206 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 208 includes and/or is representative of a platform 210 for content services 212. The platform 210 abstracts underlying functionality of hardware (e.g., servers) and software resources of the cloud 208. The content services 212 may include applications and/or data that can be utilized while computer processing is executed on servers that are remote from the computing device 102. Content services 212 can be provided as a service over the Internet and/or through a subscriber network, such as a cellular or Wi-Fi network.

The platform 210 may abstract resources and functions to connect the computing device 102 with other computing devices. The platform 210 may also serve to abstract scaling of resources to provide a corresponding level of scale to encountered demand for the content services 212 that are implemented via the platform 210. Accordingly, in an interconnected device embodiment, implementation of functionality described herein may be distributed throughout the system 200. For example, the functionality may be implemented in part on the computing device 102 as well as via the platform 210 that abstracts the functionality of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

In the discussion that follows, various sections describe various example embodiments. A section entitled “Deep Link Navigation Suggestions” describes how text entered into an address bar can be utilized to enable deep link navigation suggestions to be provided by a web platform. Next, a section entitled “Local Application Suggestions” describes how text entered into an address bar can be utilized to enable local application to be suggested by a web platform. Following this, a section entitled “Rich Answers” describes how the address bar can serve as a basis to enter a query to which one or more responses are provided. Next, a section entitled “Prioritization Rules” describes various prioritization rules in accordance with one or more embodiments. Last, a section entitled “Example Device” describes aspects of an example device that can be utilized to implement one or more embodiments.

Having described example operating environments in which the inventive principles can be employed, consider now a discussion of various embodiments.

Deep Link Navigation Suggestions

In one or more embodiments, the web platform, e.g., the web browser, includes an address bar and, as keystrokes are entered into the address bar, a user interface container is populated with relevant suggestions from a combination of various data sources, including local sources and one or more remote sources, based on matching character input. Local data sources can include a user's browsing history, favorites, pinned sites, typed URLs, and the like. Remote sources can include service providers such as companies like Microsoft and others.

In one or more embodiments, the relevant suggestions can include deep link navigation suggestions. The deep link navigation suggestions that are returned from the service provider constitute suggestions for which the service provider has a high confidence that the top level domain is where the user intends to navigate, based on their entered keystrokes. The service provider ascertains confidence levels by maintaining data associated with keystrokes entered by large numbers of users and how the corresponding character strings map to navigation destinations.

In addition to returning the top level domain, the service provider also returns links to the most popular pages within that particular domain. So, for example, over time as users browse to various top level domains, they also browse to deeper levels or links within those domains. In these instances, the service provider maintains data or statistics associated with the most popular deeper levels within a domain which, in turn, can then be used to return suggestions to a web browser as described above and below. This is based on the notion that users who navigate to the top level domain will statistically tend to navigate to a deep link within that domain. The deep link navigation suggestions are based on these heuristics and attempt to surface relevant pages to the user as quickly as possible.

Once these deep link navigation suggestions are returned to the web browser, suggestions can be displayed in the user interface container and provide entry points for a user to quickly navigate to pages within the top level domain. So, for example, when a user selects a particular suggestion, they will be navigated to the results pages of their default search provider. The search provider may not necessarily be affiliated with same entity with which the service provider is affiliated.

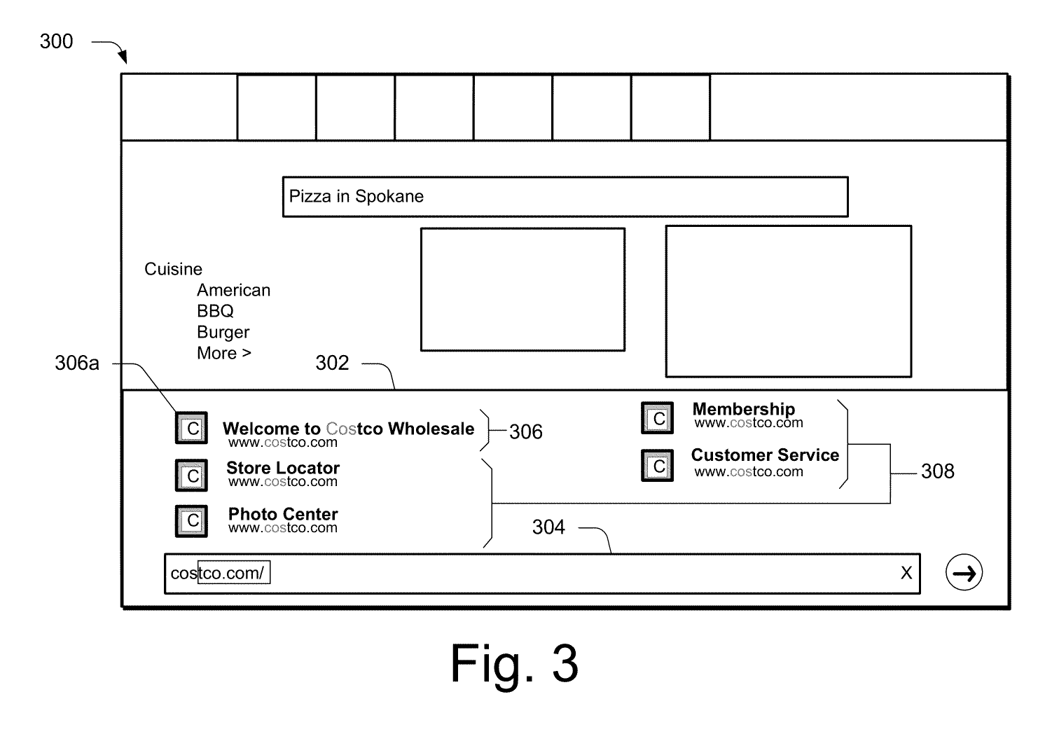

As an example, consider FIG. 3. There, a web browser user interface is shown generally at 300 in accordance with one or more embodiments. In this particular example, the web browser user interface 300 includes a user interface container 302 having an address bar 304. The address bar can be utilized by a user to type in text to cause a browser navigation activity. As the user types text into the address bar 304, the address bar can provide auto complete suggestions. In this particular example, the user has typed “cos” into the address bar and the address bar has provided the auto complete text “tco.com” for a recommendation of “costco.com”.

The address bar also has another function. In the illustrated and described embodiment, as the user types in keystrokes, each keystroke or a collection of keystrokes can be provided to a remote service provider. The service provider receives the keystroke(s) and conducts a search to identify potential navigation targets. It does this by comparing the received keystroke(s) to data that the service provider maintains that defines associations between entered keystrokes and navigation destinations across a large number of users. The service provider then returns the potential navigation targets in the form of suggestions to the web browser which, in turn, can display the suggestions in the user interface container 302. The suggestions can include a top-level domain, such as shown at 306. The suggestions can include text such as, for example, “Welcome to Costco Wholesale” along with the top level domain itself, e.g., www.costco.com. In addition, the suggestions can also include a favicon or tile 306a that is displayed along with the top level domain.

In addition, a set of deep link navigation suggestions can also be displayed, an example of which is shown at 308. The deep link navigation suggestions follow the text associated with the top level domain 306. In one or more embodiments, the deep link navigation suggestions can be arranged by how frequently users typically navigate to that particular deep link once they are on a top-level domain. In this particular example, the most popular deep link is “Store Locator” followed by “Photo Center”, and so on. In the illustrated and described embodiment, each deep link displays the top level domain with which it is associated, even though its target URL is not the top level domain. Showing the top level domain with each deep link navigation suggestion provides a degree of visual association of the set of deep link navigation suggestions. In addition, the visual association of the deep link navigation suggestions with the top level domain can also be enhanced by using the same favicon with each deep link navigation suggestion.

Now, multiple entry points are provided to the website. By simply clicking on one of the navigation suggestions, the user's browser can be navigated to that particular page. This can greatly facilitate and enhance the user's experience. As an example, consider the following.

In previous approaches, if a user wished to navigate to the customer service page on the Costco website, they could enter the Costco URL in the address bar to cause their browser to navigate to the home page for Costco. Once at the homepage, the user would typically search for a table of contents or the appropriate tab for the customer service page. By clicking on an appropriate entry in the table of contents or the associated tab, the user's browser would then be navigated to the customer service page.

Now, by displaying information associated with a top-level domain that is believed to be the subject of an intended navigation, along with multiple deep link navigation suggestions, as the user enters keystrokes into an address bar, the user can select one of the entry points to cause their web browser to be navigated to a deep link location. This can avoid the user having to conduct a navigation to the top level domain and then hunt for the appropriate deep link location. Thus, the deep link navigation suggestions are displayed in the user interface container 302 prior to any browser navigation to an intended site and without having the user physically navigate to a search page, enter a query, and then receive a page with suggestions.

As the user enters keystrokes into the address bar, the keystrokes can be provided to a service provider in any suitable way. As an example, consider the following. In one or more embodiments, when the user enters their first keystroke, it can be provided to a service provider in the form of a query so that the service provider can begin to develop suggestions that contain navigation suggestions, such as deep link navigation suggestions. If, however, a second keystroke is typed before the query for the first keystroke is dispatched, the browser does not send the first query to the service provider. If a second keystroke is typed before the first query returns from the service provider, the suggestions of the first query are not shown. If a second keystroke is typed while the suggestions of the first query are being processed by the web browser, the web browser does not show the suggestions of the first query.

Having considered an example user interface in accordance with one or more embodiments, consider now an example method in accordance with one or more embodiments.

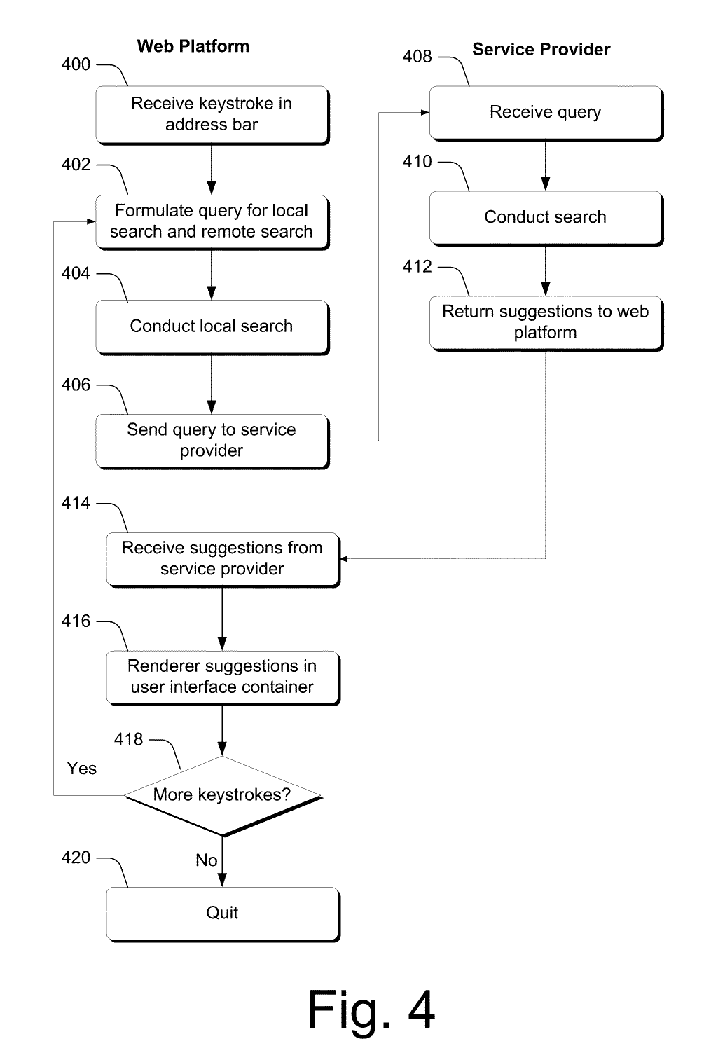

FIG. 4 is a flow diagram that describes steps in a method in accordance with one or more embodiments. The method can be implemented in connection with any suitable hardware, software, firmware, or combination thereof. In at least some embodiments, aspects of the method are implemented by a web platform such as, by way of example and not limitation, a web browser. Other aspects of the method can be performed by a remote source such as a service provider that is accessed through the Internet. This is indicated by having one portion of the flow diagram designated “Web Platform” and another portion of the flow diagram designated “Service Provider”. In addition, the flow diagram in this particular example assumes that suggestions are rendered in the user interface container for each entered keystroke. As noted above, however, such need not necessarily be the case. For example, if a second keystroke is entered very quickly after the first keystroke such that the query for the first keystroke cannot be sent prior to the second keystroke being entered, then the first query will not be sent. Hence, because there are no suggestions for the first keystroke, there are no associated suggestions to display.

Step 400 receives a keystroke in an address bar. Responsive to receiving the keystroke in the address bar, step 402 formulates a query for local search and for a remote search. Step 404 conducts a local search based on the formulated query for the local search. This step can be performed in any suitable way and can search any suitable sources, examples of which are provided above. Step 406 sends the query for the remote search to a service provider.

Step 408 receives, at the service provider, the query for the remote search. Step 410 conducts the remote search and step 412 returns suggestions associated with the search to the web platform. This step can be performed in any suitable way. For example, in at least some embodiments, the suggestions can include suggestions for a top-level domain as well as associated deep link navigation suggestions. The deep link navigation suggestions may or may not be ranked in accordance with their popularity.

Step 414 receives the suggestions from the service provider and step 416 renders the suggestions in a user interface container, an example of which is provided above. It is to be appreciated and understood that this step can also include rendering suggestions associated with the local search within the user interface container as well. Accordingly, the suggestions that appear in the user interface container constitute entry points that can be selected to cause browser navigation to a particular site. Step 418 ascertains whether any additional keystrokes have been entered in the address bar. If additional keystrokes have been entered in address bar, the method returns to step 402 to formulate queries for both local and remote searches. If, on the other hand, no additional keystrokes have been entered in the address bar, step 420 terminates the process.

Having considered deep link navigation suggestions in accordance with one or more embodiments, consider now local application suggestions.

Local Application Suggestions

In one or more embodiments, as a user enters keystrokes in the web platform's address bar, the user interface container is populated with relevant suggestions associated with local applications. The relevant suggestions can be provided through a navigation intent-based local application search, based on the user's entered keystrokes.

Today, many websites have associated local applications that can be acquired by users and installed on their computing devices. The local applications are site-specific and provide an immersive user experience that is designed specifically for content of a particular website. For example, Netflix maintains a website that includes web content that can be consumed by a web browser. Hence, the website's content can be explored using the typical browser navigation instrumentalities. Netflix also maintains a local application that is designed to be installed locally and provide a user experience specifically defined by Netflix. This experience may include a user interface that is different from the web browser's user interface (e.g., by including specifically branded content and the like) and navigation instrumentalities that are different from the web browser's navigation instrumentalities. The local application can typically be installed on the user's computer and can be accessed by clicking on or otherwise selecting a branded favicon that can appear on the computer's desktop, start menu, or taskbar. By virtue of being designed by a particular entity for interacting with the entity's content, an assumption can be made that the local application likely provides a better user experience than simply interacting with the entity's content using a web browser. Thus, entities with local applications may desire for users to interact with their content using their tailored local application, rather than a web browser.

In one or more embodiments, as a user enters keystrokes and before a navigation is conducted, a navigation intent-based local application search is conducted to ascertain whether the user's entered keystrokes pertain to a website that has an associated local application. This can be performed in any suitable way. For example, web developers can insert HTTP meta-tags in their webpages advertising the presence of a local application. Web crawler data can be leveraged to ascertain which top level domains advertise local applications. Alternately or additionally, crowdsourcing can be conducted on a catalog of local applications to ascertain domains for which large numbers of individuals believe local applications exist. Alternately or additionally, application developers can indicate a canonical association with a domain that they own in a search engine's portal.

If the user's entered keystrokes pertain to a website that has an associated local application, the web platform ascertains whether the local application is installed on the user's computer. This can be done in any suitable way. For example, in at least some embodiments an API call can be made and a hash of the local application's package can be provided. The API can be used to check to see if the local application is installed and can return with either a “yes” or “no” answer.

If the local application is installed on the user's computer, the user interface container is populated with a selectable entry point instrumentality that can enable the user to directly launch the local application. If, on the other hand, the local application is not installed on the user's computer, the user interface container is populated with a selectable entry point instrumentality to enable the user to install the local application. This entry point can include a link to an application store from which the local application can be obtained and installed.

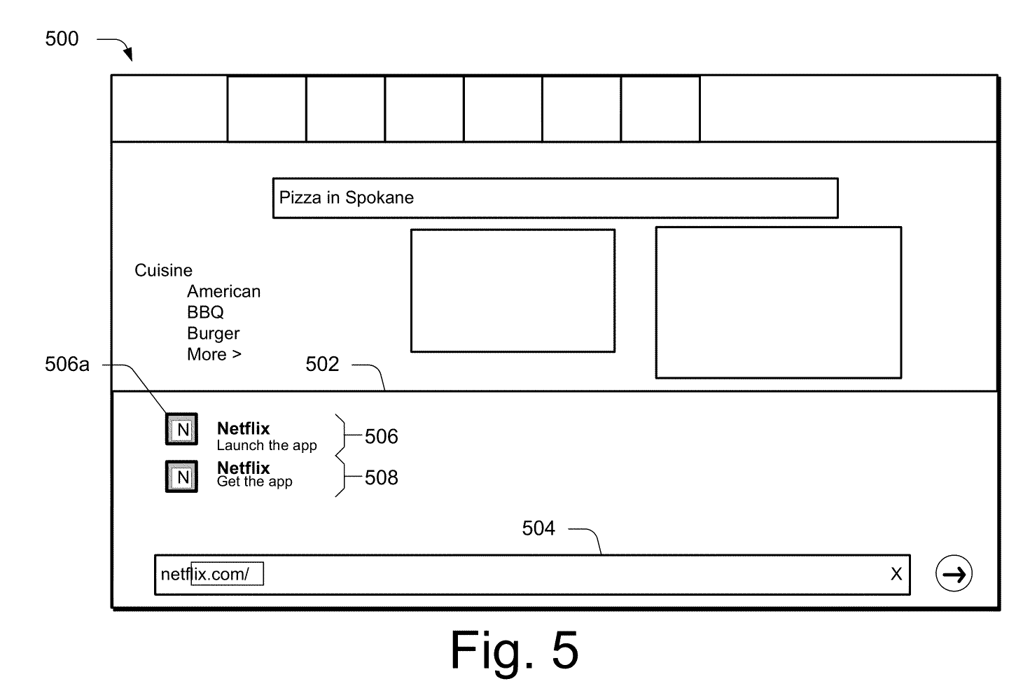

As an example, consider FIG. 5. There, a web browser user interface is shown generally at 500 in accordance with one or more embodiments. The web browser user interface 500 includes a user interface container 502 having an address bar 504. The address bar can be utilized by a user to type in text to cause a browser navigation. As the user types text into the address bar 504, the address bar can provide auto complete suggestions. In this particular example, the user has typed “netf” into the address bar and the address bar has provided the auto complete text “lix.com” for a recommendation of “netflix.com”.

In the illustrated and described embodiment, as the user types in keystrokes, each keystroke or a collection of keystrokes can be provided to a remote source, such as a service provider. The service provider receives the keystroke(s) and conducts a search to identify whether there are any local applications that match the user's keystrokes. This can be done by first ascertaining a top-level domain associated with the keystrokes and then, for the top-level domain, ascertaining whether it has an associated local application. The service provider then returns to the browser with the names of the local applications and, in some instances, information that can be used to identify the local applications, e.g. a hash of each local application's package. The browser can now ascertain whether the local application is installed on the user's computer. If the local application is installed on the user's computer, a selectable entry point instrumentality, such as the one at 506, can be displayed in the user interface container 502. By selecting this instrumentality, the user can automatically launch the local application. If, on the other hand, the local application is not installed on the user's computer, a selectable entry point instrumentality, such as the one shown at 508, can be displayed in the user interface container 502. This informs the user that there is a local application available before the user navigates to a particular website. By selecting this instrumentality, an application store can be launched with the corresponding app entry, e.g., “Netflix”, being used for a search in the application store. From there, the user can install the local application.

Having considered an example user interface in accordance with one or more embodiments, consider now an example method in accordance with one or more embodiments.

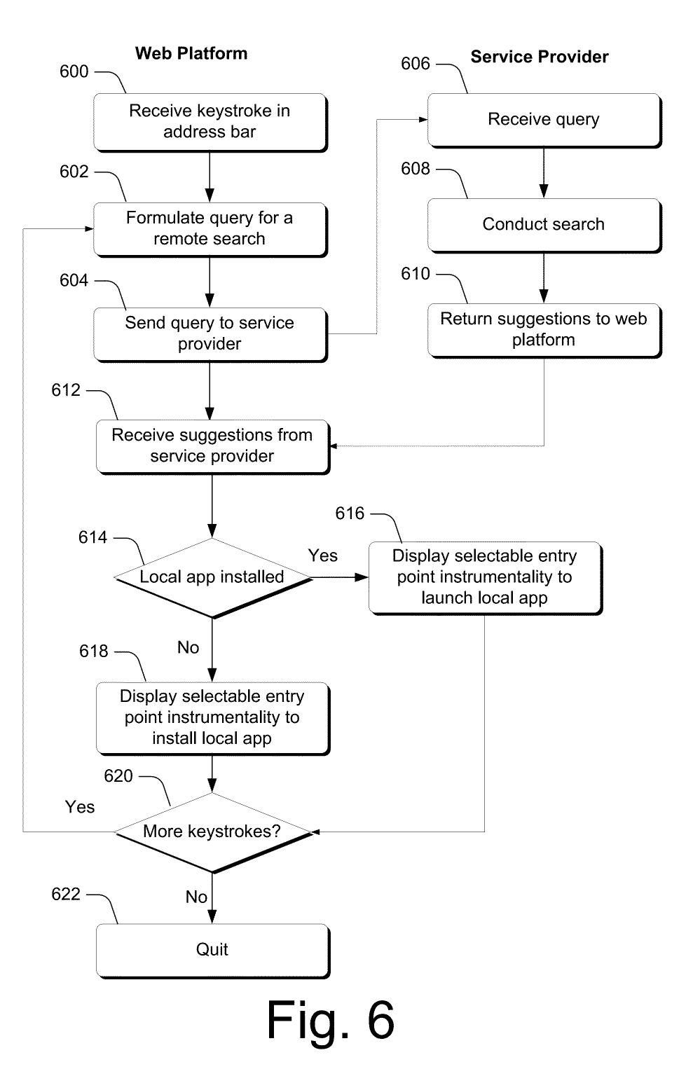

FIG. 6 is a flow diagram that describes steps in a method in accordance with one or more embodiments. The method can be implemented in connection with any suitable hardware, software, firmware, or combination thereof. In at least some embodiments, aspects of the method are implemented by a web platform such as, a way of example and not limitation, a web browser. Other aspects of the method can be performed by a remote source such as a service provider that is accessed through the Internet. This is indicated by having one portion of the flow diagram designated “Web Platform” and another portion of the flow diagram designated “Service Provider”. In addition, the flow diagram in this particular example assumes that suggestions are rendered in the user interface container for each entered keystroke. As noted above, however, such need not necessarily be the case. For example, if a second keystroke is entered very quickly after the first keystroke such that the query for the first keystroke cannot be sent prior to the second keystroke being entered, then the first query will not be sent. Hence, because there are no suggestions for the first keystroke, there are no associated suggestions to display.

Step 600 receives a keystroke in an address bar. Responsive to receiving the keystroke in the address bar, step 602 formulates a query for a remote search, such as for a service provider. Step 604 sends the query for the remote search to a service provider.

Step 606 receives, at the service provider, the query for the remote search. Step 608 conducts the remote search and step 610 returns suggestions to the web platform. The step can be performed in any suitable way. For example, in at least some embodiments, the suggestions can include one or more local application suggestions which may or may not have a ranked order. If ranked, any suitable criteria can be used, e.g., popularity, new-to-old, and the like.

Step 612 receives the suggestions from the service provider and step 614 ascertains whether one or more of the local applications are installed. Examples of how this can be done are provided above. If one or more of the local applications are installed, step 616 displays, in the user interface container, a selectable entry point instrumentality to launch one or more of the local applications. An example instrumentality is described above. If, on the other hand, the local application is not installed, step 618 displays, in the user interface container, a selectable entry point instrumentality to install the local application. An example of how this can be done is provided above.

Step 620 ascertains whether any additional keystrokes have been entered in the address bar. If additional keystrokes have been entered in address bar, the method returns to step 602 to formulate queries for the remote searches. If, on the other hand, no additional keystrokes have been entered in the address bar, step 622 terminates the process.

Having considered local application suggestions in accordance with one or more embodiments, consider now how the user interface container can be utilized to provide rich answers.

Rich Answers

In one or more embodiments, the address bar of the user interface container can be utilized to receive a query from the user. The query can then be sent to a service provider which can then return an answer that can be displayed in the user interface container.

As an example, consider the following. Living in Seattle, the constant weather changes are hard to predict. Oliver is headed downstairs to meet a friend for lunch but it looks gray and windy outside. Oliver wonders if he needs a sweater. Oliver types “Bellevue wea” in the address bar of the user interface container. The character string is sent to a service provider which returns an answer to his query. The answer can include both visual and text information that is displayed in a tile in the user interface container. Oliver can now select the tile to be navigated to a results page with “Bellevue weather” as the entered query.

Likewise, Peter keeps reading about XYZ Corporation's stock not doing very well. Peter wants to know its current stock price. Accordingly, Peter types “XYZ” into the address bar of the user interface container thus providing a financial query. This text string is then sent to the service provider which, in turn, returns an answer which can include visual and textual information about XYZ Corporation's stock. The answer can then be displayed in a tile in the user interface container. Peter can now select the tile and is navigated to a results page with “XYZ stock” as the entered query.

Having considered how rich answers can be provided in accordance with one or more embodiments, consider now various prioritization rules in accordance with one or more embodiments.

Prioritization Rules

It can be a common scenario that more suggestions are returned that match a user's input than the allotted real estate in the user interface container will allow. While the user interface container can be scrollable, it can be desirable to avoid having the user have to use the scroll mechanism. In this situation, suggestions can be prioritized and surfaced in a manner that attempts to surface the most relevant or personalized suggestions for the user. In accordance with one or more embodiments, various types of prioritization rules can be utilized to enhance the user's experience. These rules can include general rules, data type-specific rules, ranking rules, and ordering rules.

General rules apply globally to the user interface container. An example of a general rule can be one that defines how information is to be provided to the service provider. For example, a general rule may exist that specifies that if a single character is entered in the address bar, that single character is provided to the service provider so that the service provider can conduct its search. Alternately, a general rule may specify that no less than two characters are to be provided to the service provider.

Data type-specific rules and heuristics determine the number of each data type to be surfaced in the user interface container. For example, recall that data types can include, by way of example and not limitation, typed URLs, pinned sites, favorites, history, and the like. Data types can also include deep link navigation suggestions, domain suggestions, rich answers, search suggestions, and local application suggestions. The data type-specific rules can define how many of each data type to surface in the user interface container. The data type-specific rules can also define a ranking as between data types. For example, data types received from the remote source can be ranked as follows: deep link navigation suggestions, domain suggestions, rich suggestions, search suggestions, and local application suggestions.

Ranking rules can be utilized to determine the number of each data type to be surfaced in the user interface container. For example, a maximum number of each local data type can be defined. In cases where more than the allotted number of a particular data type matches the user's input, the local data types with the highest visit frequency can be surfaced. Remote data types can be ranked in any suitable way. For example, with respect to local applications, such applications can be ranked in terms of newness or popularity.

Ordering rules and heuristics can be utilized to determine how suggestions are ordered in the user interface container. In one or more embodiments, ordering rules can be utilized to order the suggestions in a top-down, left-right manner. This ordering can be adjusted to accommodate bi-directional languages. Suggestions can be displayed in the user interface container based on a hierarchy of data types. For example, for local suggestions the hierarchy may be as follows: typed URLs, pinned sites, favorites, and history. Within each local data type, items can be sorted by highest visit frequency. Remote suggestions can be ranked by either the web platform or the service provider.

Having considered various embodiments, consider now a discussion of example device that can be utilized to implement the embodiments described above.

Example Device

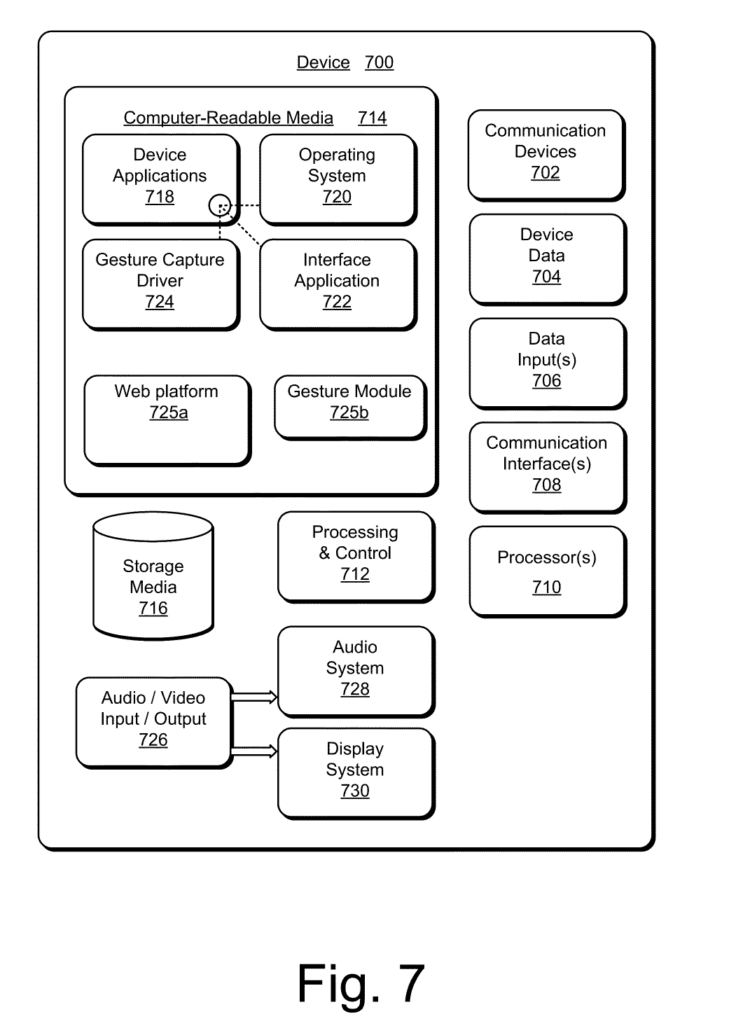

FIG. 7 illustrates various components of an example device 700 that can be implemented as any type of portable and/or computer device as described with reference to FIGS. 1 and 2 to implement embodiments of the animation library described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable or readable instructions to control the operation of device 700 and to implement the embodiments described above. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 77. The device applications 718 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 718 also include any system components or modules to implement embodiments of the techniques described herein. In this example, the device applications 718 include an interface application 722 and a gesture-capture driver 724 that are shown as software modules and/or computer applications. The gesture-capture driver 724 is representative of software that is used to provide an interface with a device configured to capture a gesture, such as a touchscreen, track pad, camera, and so on. Alternatively or in addition, the interface application 722 and the gesture-capture driver 724 can be implemented as hardware, software, firmware, or any combination thereof. In addition, computer readable media 714 can include a web platform 725a and a gesture module 725b that functions as described above.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

### CONCLUSION

Various embodiments provide a web platform, e.g., a web browser, which is designed to facilitate user access to websites in a quick and efficient manner. The web platform includes an address bar and, as keystrokes are entered into the address bar, a user interface container is populated with relevant suggestions from a combination of various data sources based on matching character input. Data sources can include a user's browsing history, favorites, and domain suggestions from a remote source, such as a service provider.

In one or more embodiments, the relevant suggestions can include deep link navigation suggestions, search suggestions, local application suggestions, and the like.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
receiving one or more keystrokes in an address bar of a web platform;
responsive to receiving the one or more keystrokes, formulating a query for a local search and a remote search;
conducting a local search based on the query;
sending the query for the remote search to a service provider;
receiving suggestions for the query from the service provider;
rendering the suggestions and suggestions from the local search in a user interface container, the rendered search suggestions including a navigable entry point to a top level domain and one or more navigable entry points to deep links within the top level domain.

2. The computer-implemented method of claim 1, wherein the web platform comprises a web browser.

3. The computer-implemented method of claim 1, wherein the web platform comprises a local application.

4. The computer-implemented method of claim 1, wherein said rendering comprises including text in addition to the top level domain and the one or more deep links, respectively.

5. The computer-implemented method of claim 1, wherein said rendering comprises including a favicon with at least the top level domain.

6. The computer-implemented method of claim 1, wherein the navigable entry points to the deep links are arranged by how frequently users navigate to a respective deep link.

7. The computer-implemented method of claim 1, wherein said rendering is performed without conducting a navigation.

8. The computer-implemented method of claim 1, wherein the address bar is configured to receive queries and the user interface container is configured to display answers to queries entered into the address bar.

9. The computer-implemented method of claim 1, wherein the address bar is configured to receive queries and the user interface container is configured to display answers to queries entered into the address bar, wherein the queries comprise weather queries.

10. The computer-implemented method of claim 1, wherein the address bar is configured to receive queries and the user interface container is configured to display answers to queries entered into the address bar, wherein the queries comprise financial queries.

11. One or more computer readable storage media embodying computer readable instructions which, when executed, implement a method comprising:
receiving one or more keystrokes in an address bar of a web platform;
responsive to receiving the one or more keystrokes, formulating a query for a remote search;
sending the query for the remote search to a service provider;
receiving suggestions for the query from the service provider;
displaying, in a user interface container, a selectable entry point instrumentality associated with a local application appearing in the suggestions.

12. The one or more computer readable storage media of claim 11 further comprising:
after receiving the suggestions, ascertaining whether the local application is installed on a local computing device; and
responsive to the local application being installed on the local computing device, the selectable entry point instrumentality is configured to enable the local application to be launched.

13. The one or more computer readable storage media of claim 11 further comprising:
after receiving the suggestions, ascertaining whether the local application is installed on a local computing device; and
responsive to the local application not being installed on the local computing device, the selectable entry point instrumentality is configured to enable the local application to be installed.

14. The one or more computer readable storage media of claim 11, wherein the address bar is configured to receive queries and the user interface container is configured to display answers to queries entered into the address bar.

15. The one or more computer readable storage media of claim 11, wherein the address bar is configured to receive queries and the user interface container is configured to display answers to queries entered into the address bar, wherein the queries comprise weather queries.

16. The one or more computer readable storage media of claim 11, wherein the address bar is configured to receive queries and the user interface container is configured to display answers to queries entered into the address bar, wherein the queries comprise financial queries.

17. The one or more computer readable storage media of claim 11, wherein the web platform comprises a web browser.

18. A computing device comprising:
one or more processors;
one or more computer readable storage media;
instructions embodied on the one or more computer readable storage media which, when executed, implement a web platform comprising:
a user interface container including an address bar into which addresses can be entered to cause the web platform to perform a navigation to a website;
the user interface container being configured to:
display deep link navigation suggestions associated with text entered into the address bar; and
display local application suggestions associated with text entered into the address bar.

19. The computing device of claim 18, wherein the user interface container is configured to display answers to queries that are entered in the address bar.

20. The computing device of claim 18, wherein the user interface container is configured to display the deep link navigation suggestions without causing the web platform to conduct a navigation.
